(19) United States
(12) Patent Application Publication
(10) Pub. No.: US 2012/0210640 A1
(43) Pub. Date: Aug. 23, 2012

(54) METHODS AND APPARATUS FOR GROWING PLANTS

(76) Inventor: David Ivanovic, Gordon (AU)

(21) Appl. No.: 13/503,185

(22) PCT Filed: Oct. 22, 2010
(86) PCT No.: PCT/AU2010/001407

§ 371 Date: Apr. 24, 2012

(30) Foreign Application Priority Data
Oct. 23, 2009 (AU) 2009905159

(51) Int. Cl. A01G 7/02; A01G 1/00; A01H 5/00

(52) U.S. Cl. 47/58.1 LS; 800/298; 47/1.1 R; 47/58.1 R

(57) ABSTRACT

An embodiment includes an enclosure having a nutrient bed for retaining and providing nutrients to plants grown therein. An adjustment mechanism provided for adjusting the level of one or more environmental variables therein so as to at least partially simulate the growing conditions found at a specific altitude. Exemplary environmental variables include water levels, broad-spectrum light intensity, UV light intensity, pH, nutrients, air temperature, soil temperature, atmospheric carbon dioxide, atmospheric oxygen, atmospheric pressure and combinations thereof. The adjustment mechanism may include one or more broad-spectrum/full spectrum lights, UV generating lights, skylights, vacuum/pressure pumps, hypoxicators, oxygen generators, carbon dioxide regulators, heaters, air conditioning units and so forth.

### FIELD OF THE INVENTION

The present invention relates to the growing of plants. Embodiments of the present invention find application, though not exclusively, in methods for altering the characteristics of a plant.

### BACKGROUND OF THE INVENTION

Many plants, including food crops, have been sourced from their native regions and subsequently grown around the world. Accordingly, many plants can be grown across a range of different environmental conditions depending somewhat on the particular variety utilised. However, some plants and varieties are especially suited to specific conditions such as a particular range of temperature. As such, the characteristics and growth of a plant will depend somewhat on the prevailing and extreme conditions of the area in which it is grown.

Environmental conditions vary from location to location and also with altitude and latitude. For example, the intensity of light and, in particular the intensity of UV light, increases with altitude. High altitude plants have evolved to deal with high UV levels by developing structures such as hairy trichomes on leaves that serve to reflect light while trapping additional moisture. Furthermore, as altitude increases, air pressure decreases bringing a concomitant reduction in the levels of oxygen and carbon dioxide. Of particular note are differences in temperature, whereby high altitude plants must typically deal with lower temperatures. This is especially significant in terms of night time and soil temperatures which are often lower in highland habitats.

These environmental differences affect plant characteristics such as yield, flavor and the composition of nutrients and antioxidants. For example, it has been noted that naturally occurring antioxidant levels in plants of the same species vary depending somewhat on the altitude at which the plants are found (Wildi and Lutz, 1996. Plant Cell and Environment, 19:138-46). In this regard, the Goji berry (Lycium barbarum or L. chinense) which is also known as the wolfberry or Chinese wolfberry is particularly rich in antioxidants and berries grown at high altitudes, such as those grown at high altitude in Tibet, are prized for their high nutrient density and antioxidant levels.

### SUMMARY OF THE INVENTION

It is an object of the present invention to overcome, or substantially ameliorate, one or more of the disadvantages of the prior art, or to provide a useful alternative.

In one aspect of the present invention there is provided an enclosure for growing plants therein, the enclosure including adjustment means for adjusting the level of one or more environmental variables therein so as to at least partially simulate the growing conditions found at a specific altitude.

Preferably, the one or more environmental variables are selected from water levels, broad-spectrum light intensity, UV light intensity, pH, nutrients, air temperature, soil temperature, atmospheric carbon dioxide, atmospheric oxygen and atmospheric pressure.

Preferably, the adjustment means are selected from a water irrigation system, a hydroponic system, a broad spectrum light, a UV light, a nutrient supplementation system, an air heater, a soil heater, an air conditioning unit, a carbon dioxide generator, a carbon dioxide scrubber, an oxygen generator, a hypoxicator, a pressure pump, a vacuum pump and combinations thereof.

Preferably, the enclosure includes at least one sensor for measuring the level of at least one environmental variable.

Preferably, the enclosure includes an automated control system for maintaining at least one environmental variable at a predetermined level, the automated control system being operably linked to a sensor and in control of an adjustment means corresponding to the environmental variable.

In one or more embodiments, the level of one or more variables is adjusted so as to at least partially simulate growing conditions at a higher altitude than the altitude at which the enclosure is located.

In one or more embodiments, the air pressure within the enclosure is reduced compared with natural levels found at the altitude at which the enclosure is located.

In one or more embodiments, the oxygen level within the enclosure is reduced compared with natural levels found at the altitude at which the enclosure is located.

In one or more embodiments, the broad-spectrum light and/or UV light intensity within the enclosure is increased compared with natural levels found at the altitude at which the enclosure is located.

In one or more embodiments, the overall and/or night-time temperature within the enclosure is reduced compared with natural temperatures found at the altitude at which the enclosure is located.

In one or more embodiments, the level of one or more of said variables are adjusted so as to at least partially simulate the growing conditions at a lower altitude than the altitude at which the enclosure is located.

In one or more embodiments, the air pressure within the enclosure is increased compared with natural levels found at the altitude at which the enclosure is located.

In one or more embodiments, the oxygen level is increased within the enclosure compared to the natural levels found at the altitude at which the enclosure is located.

In one or more embodiments, broad-spectrum light and/or UV light levels within the enclosure are reduced compared with natural levels found at the altitude at which the enclosure is located.

In one or more embodiments, the overall and/or night-time temperature is increased compared with natural temperatures found at the altitude at which the enclosure is located.

In another aspect of the invention there is provided a plant grown in an enclosure according to the invention.

In another aspect of the invention there is provided a harvested plant, or part thereof, derived from a plant grown in an enclosure according to the invention.

In another aspect of the invention there is provided a plant extract obtained from a plant grown in an enclosure according to the invention.

In another aspect of the invention there is provided a method of altering the characteristics of a plant comprising growing the plant at a first altitude and adjusting the level of one or more environmental variables in proximity to the plant so as to at least partially simulate the growing conditions found at a second altitude.

Preferably, the one or more environmental variables are selected from water levels, broad-spectrum light intensity, UV light intensity, soil type, pH, nutrients, air temperature, soil temperature, atmospheric carbon dioxide, atmospheric oxygen and atmospheric pressure.

Preferably, the plant is selected from goji berry/wolf berry (Lycium barbarum or L. chinense), blueberry (Vaccinium species), tea (Camellia sinensis varieties) and coffee (Coffea canephora or Coffea arabica).

Preferably, one of the characteristics is the level and/or quality of antioxidants found in said plant or part thereof.

Preferably, the level and/or quality of one or more antioxidants are increased.

In another aspect of the invention there is provided a computer control system for controlling the growth of plants at a first altitude, the control system being responsive to input obtainable from at least one sensor disposed in proximity to said plants so as to determine a control output for controlling one or more environmental adjustment means to adjust the level of one or more environmental variables in proximity to said plants to expose said plants to growing conditions which at least partially simulate the growing conditions found at a second altitude.

Preferably, the computer control system further includes data relating to the levels of a plurality of environmental variables that occur naturally at each of a plurality of different altitudes.

Preferably, the computer control system includes input means to allow a user to select a specific altitude whereby the control system queries the data set for that altitude and adjusts one or more of the environmental conditions in proximity to the plants to a level at or near a level that occurs naturally at that altitude.

In another aspect of the invention there is provided a computer control system for controlling the growth of plants at a first altitude, the control system being responsive to user input indicative of a target altitude so as to determine a control output for controlling one or more environmental adjustment means to adjust the level of one or more environmental variables in proximity to one or more plants to expose the plants to growing conditions which at least partially simulate the growing conditions found at the target altitude.

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

FIG. 1 is a partially cut-away perspective view of an enclosure for growing plants according to the invention.

### DETAILED DESCRIPTION OF PREFERRED EMBODIMENTS OF THE INVENTION

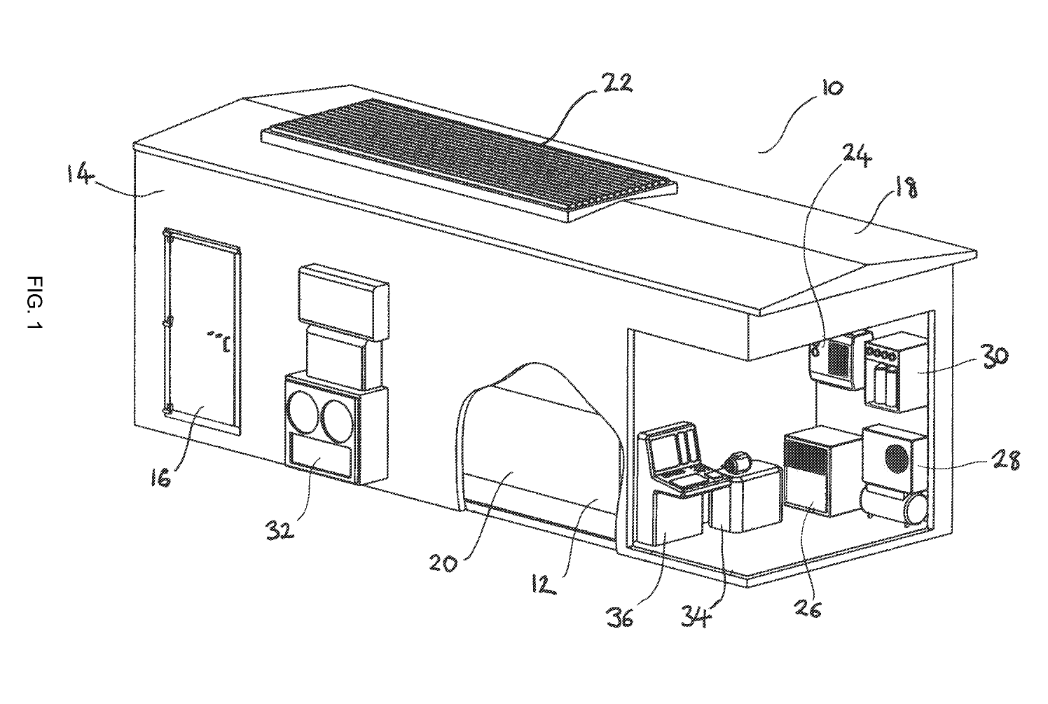

Referring to FIG. 1, there is illustrated an enclosure 10 according to the invention for growing plants therein. The enclosure comprises a floor 12, walls 14, access door 16 and a roof 18. A nutrient bed 20 is also located on the floor for retaining and providing nutrients to plants grown therein.

The enclosure further includes adjustment means for adjusting the level of one or more environmental variables therein so as to at least partially simulate the growing conditions found at a specific altitude. This includes means for adjusting the level of one or more environmental variables selected from water levels, broad-spectrum light intensity, UV light intensity, pH, nutrients, air temperature, soil temperature, atmospheric carbon dioxide, atmospheric oxygen, atmospheric pressure and combinations thereof.

In the illustrated embodiment, the enclosure includes broad-spectrum/full spectrum lights (not shown) which generate “white light” which includes UV light. The enclosure also includes UV generating lights (not shown) to further increase UV light levels if necessary. These lights may also be used to artificially control the duration of time in which plants are exposed to light where desired, i.e. to control day length. As light intensities are higher at higher altitudes, these lights can be used to simulate higher altitude growing conditions by providing additional broad spectrum and UV light as required. The roof of the enclosure also includes an adjustable sunlight control system in the form of a skylight 22 to allow or restrict the passage of ambient light into the enclosure. Accordingly, the skylight may be partially closed to reduce the amount of light reaching the plants thereby to at least partially simulate the growing conditions of a lower altitude.

In the present embodiment, the enclosure is constructed so as to be air tight and resistant to differences between internal and external pressures. However, in other embodiments, an enclosure may not be air tight depending on the particular applications required.

Air pressure drops with increasing altitude thereby reducing the levels of oxygen and carbon dioxide. The approximate air pressure and oxygen concentrations at various altitudes are exemplified in Table 1, although it will be appreciated that the exact figures in any given location may vary due to ambient conditions.

TABLE 1
Air pressure and oxygen levels at various altitudes.

| | Oxygen | Atmospheric | Altitude |
|---|---|---|---|
| Altitude(m) | Percent | pressure kPa | Category |
| 0 | 20.9 | 101.3 | Low |
| 300 | 20.2 | 97.6 | Low |
| 600 | 19.7 | 94.2 | Low |
| 900 | 18.9 | 90.9 | Medium |
| 1200 | 18.1 | 87.5 | Medium |
| 1500 | 17.4 | 84.4 | Medium |
| 1800 | 16.8 | 81.2 | Medium |
| 2100 | 16.2 | 78.2 | Medium |
| 2400 | 15.6 | 75.2 | High |
| 2700 | 15.0 | 72.4 | High |
| 3000 | 14.4 | 69.4 | High |
| 3300 | 13.9 | 67.6 | High |
| 3600 | 13.4 | 64.5 | High |
| 3900 | 12.9 | 62.0 | Very High |
| 4200 | 12.4 | 59.5 | Very High |
| 4500 | 11.9 | 57.2 | Very High |
| 4800 | 11.5 | 54.9 | Very High |
| 5100 | 11.1 | 52.7 | Very High |
| 5400 | 10.7 | 50.4 | Extreme |
| 5700 | 10.3 | 50.0 | Extreme |
| 6000 | 9.9 | 48.2 | Extreme |
| 6300 | 9.5 | 45.9 | Extreme |
| 6700 | 9.6 | 43.7 | Extreme |
| 7000 | 8.6 | 41.4 | Extreme |
| 7300 | 8.3 | 39.2 | Extreme |
| 7600 | 8.6 | 37.6 | Extreme |
| 7900 | 7.7 | 36.1 | Ultra |
| 8200 | 7.4 | 34.6 | Ultra |
| 8500 | 7.1 | 33.1 | Ultra |
| 8848 | 6.7 | 31.6 | Ultra |

The illustrated enclosure includes a vacuum/pressure pump 24 to remove or add air from the enclosure as required. The removal of air reduces internal atmospheric pressure, and thereby reduces the levels of oxygen and carbon dioxide to simulate the growing conditions experienced at higher altitudes. Conversely, the pressure pump may be used to reverse these conditions, by adding atmosphere (which includes both oxygen and carbon dioxide) which increases internal air pressure and simulates levels found at a lower altitude. It should be noted that “higher” and “lower” pressures/levels are relative to the levels external to the enclosure at the location in which it is used.

As an alternative to reducing air pressure, a hypoxicator 26, allows the removal of oxygen from the enclosure to reduce the level of oxygen and at least partially simulate the growing conditions found at an altitude which is higher than the location of the enclosure. Conversely, the oxygen generator 28 allows for oxygen levels to be increased inside the enclosure to simulate growing conditions at a lower altitude. Similarly, the carbon dioxide regulator 30 serves to increase or decrease the level of carbon dioxide as required.

Oxygen generators are known in the art and include chemical oxygen generators which typically rely on chlorate reactions to produce oxygen. Also known in the art are pressure swing adsorption (PSA) oxygen generators which are preferred. Hypoxicators are also known in the art for reducing oxygen levels in air and these also include pressure swing adsorption systems. Carbon dioxide may be provided from gas storage tanks or CO₂ generators as are well known which typically rely on chemical reactions to release CO₂ from materials such as calcium carbonate. Carbon dioxide removal may be achieved using methods that absorb carbon dioxide such as via a regenerative carbon dioxide removal system or other systems as are known in the art.

Of particular significance is the ability to control temperature which often differs considerably between higher and lower altitudes in the natural environment. In this respect, the enclosure includes a soil heater (not shown) for at least partially simulating warmer soil conditions at a lower altitude. The enclosure also includes a reverse cycle air conditioning unit 32 which can cool air to simulate higher altitudes or warm air to simulate lower altitudes as required.

High altitude soils also tend to be more alkaline. Accordingly, in some embodiments, the enclosure may include means to adjust pH. This is most easily accomplished where a hydroponic system is employed, i.e. where plants are grown directly in a nutrient bed that comprises a hydroponic solution. In this embodiment, the pH of the hydroponic solution is monitored and adjusted to control pH, with higher pH values used to simulate higher altitudes and lower pH values (more acidic) used to simulate lower altitudes. Alternatively, where a soil bed is used, pH may be controlled by the use of additives in the water supplied to the plants or by addition of agents directly to the soil. Additives for controlling soil pH are well known in the art and include limes for raising pH and such agents as Urea, urea phosphate, ammonium nitrate, ammonium phosphates, ammonium sulfate, monopotassium phosphate and manure for lowering pH.

Similarly, the level and composition of nutrients may also be adjusted to suit the desired altitude for simulation. Low nutrient availability is typical of alpine soils due to slow decomposition and mineralization of organic matter at low temperatures. Accordingly, lower nutrient levels may be used to simulate nutrient availability at higher altitudes. Conversely, higher nutrient levels may be used to simulate lower altitudes. Notably the addition of organic matter has the dual effect of lowering pH and increasing nutrient levels which are typical of growing conditions at lower altitudes.

As indicated, rainfall also tends to be reduced in alpine locations and higher rainfall normally occurs at lower altitudes. Accordingly the water supply or hydroponic system may be adjusted to control the supply of water to the plants to simulate higher or lower altitudes as desired. In the illustrated embodiment, water is supplied to the nutrient bed of soil via an irrigation system fed by a water pump 34.

The enclosure further includes an automated control system 36 for maintaining a plurality of the aforementioned environmental variables at predetermined levels or within predetermined ranges. The automated control system is operably linked to at least one sensor for sensing the level of an environmental variable. The control system is also in control of at least one adjustment means, wherein the sensor and adjustment means correspond to the same environmental variable allowing the control system to monitor and control the level of that environmental variable.

The computer control system further includes data relating to the levels of a plurality of environmental variables that occur naturally at each of a plurality of different altitudes. This system also includes input means to allow a user to select a specific target altitude. The user inputs a selected target altitude and the control system then queries the data set for that altitude to determine the naturally occurring levels for each environmental variable at that altitude. The control system then adjusts one or more of the environmental conditions in proximity to the plants to a level or a range that occurs naturally at that altitude to at least partially simulate the growing conditions found at that altitude.

Some embodiments of the invention feature a computer control system for controlling the growth of plants at a first altitude. The control system has user operable input means to allow the user to provide an input indicative of a target altitude. In response to this input, one embodiment of the control system queries a database comprising information on the levels of environmental variables across a range of different altitudes to obtain information on the naturally occurring levels of these variables at or close to the target altitude. However, in another embodiment the control system calculates appropriate levels for the environmental variables based upon predefined equations that are functions of the target altitude. Once the appropriate levels of the environmental variables have been determined, the control system provides a control output for controlling the environmental adjustment means to adjust the level of the environmental variables in proximity to the plants. This exposes the plants to growing conditions which at least partially simulate the growing conditions found at the target altitude.

In use, an enclosure according to the invention may be located near sea level or at a relatively low altitude and used to cultivate one or more plants species such as goji berry/wolf berry plants (Lycium barbarum or L. chinense) while at least partially simulating the growing conditions found at higher altitudes. Where goji plants are grown, these are cultivated in this manner so as to increase berry antioxidant levels for human consumption.

To prepare for growing the plants, soil is first added to the floor of the enclosure to provide a nutrient bed. The soil may optionally be contained in pots or long planters to house plants. The plants may then be grown in the enclosure, either from seed, or young or mature plants may be added to be grown in the enclosure. One or more environmental variables are then adjusted to at least partially simulate the growing conditions found at an altitude higher than the altitude at which the enclosure is located. According to this embodiment, the enclosure includes a vacuum pump which is used to reduce air pressure inside the enclosure and thereby reduce the levels of oxygen and carbon dioxide. Accordingly the enclosure is constructed so as to be air tight and resistant to higher external pressures. In this embodiment, it is not required that the pump also work to add air to the enclosure as the enclosure may be constructed so as to have an air lock system to allow user access to the enclosure without equalizing internal and external pressures, which is particularly important for a larger enclosure. However, it will be appreciated that where differences between internal and external pressures are not desired, then a hypoxicator and/or carbon dioxide scrubber may be used to lower the levels of one or both of these gases in the enclosure. Broad spectrum/UV lights are also used to increase light intensities to the levels found at the desired higher altitude. The enclosure also includes an air conditioning unit to reduce the internal temperature. However, in other embodiments the enclosure may be configured so as to simulate lower altitudes for growing more sensitive lowland plants. It should be noted that when young or mature plants are introduced into the enclosure, these may need to be acclimatised to the different altitude-related conditions within the enclosure requiring that the environmental variables be slowly adjusted until the desired levels are reached, perhaps over several weeks or more to avoid plant damage or death.

During use, an automated control system is used to monitor the levels of the environmental variables via a number of sensors. The control system comprises a computer system which is operably linked to the relevant adjustment means for adjusting the levels of the respective environmental variables. For example, a pressure gauge may be used to determine whether or not the internal pressure is at or near the target pressure. If the pressure is too high, then the automated control system would activate the vacuum pump to lower the internal pressure until the target pressure is reached. The enclosure could also be fitted with a safety valve to prevent the internal pressure from become too low in case of any sensor failure and to protect users working inside the enclosure. In this manner the automated control system would monitor and control the levels of several environmental variables simultaneously, keeping them at or near levels selected by the user.

It will also be understood that an enclosure may be constructed and configured to allow for the adjustment of only a subset of the environmental variables discussed above. For example, an enclosure may be constructed so as to provide means to adjust only one or two variables, such as UV light levels and temperature, or a minimum number of variables in order to achieve the desired result for minimum cost. For example, an enclosure for at least partially simulating high altitude could be constructed so as to include an air conditioning system, a nutrient bed, an irrigation system and broad spectrum/UV lights for controlling water, nutrients, white light and UV light levels. Such an enclosure could be produced without the need for an air tight, pressure-resistant structure, hypoxicator, oxygen generator, or carbon dioxide regulator thus providing an enclosure at a minimal cost. As pressure resistance would not be required, the enclosure could be comprised of further low cost materials such as a metal or composite frame and sheeting material of, for example, plastic, glass or webbing.

It will also be understood that the methods of the invention do not necessarily rely on the existence of an enclosure per se whereby plants may be grown without an enclosure if atmospheric variables are not required to be adjusted. For example, plants can be grown in a field with broad/full spectrum/UV lights provided to increase UV light levels during the day. Field-grown plants may additionally or alternatively be grown in soils or hydroponic media with higher pH and/or reduced nutrient levels to more closely simulate higher altitude conditions.

The methods of the invention also relate to altering the characteristics of a plant by growing the plant at a first altitude and adjusting the level of one or more environmental variables in proximity to the plant so as to at least partially simulate the growing conditions found at a second altitude. These environmental variables may be selected from any combination of one or more of water levels, broad-spectrum light intensity, UV light intensity, soil type, pH, nutrients, air temperature, soil temperature, atmospheric carbon dioxide, atmospheric oxygen and atmospheric pressure.

It will also be appreciated that the methods and apparatus of the invention may be used to grow plants that exhibit enhanced beneficial characteristics when grown at specific altitudes. These include plants that produce enhanced levels or improved quality of antioxidants. Examples of high altitude plants that could be grown using the methods or enclosure of the invention include goji berry (wolf berry), blueberry (Vaccinium species), tea (Camellia sinensis varieties) and coffee (Coffea canephora or Coffea arabica). Many other plant species which are well known in the art may be grown in a simulated high or low altitude environment in accordance with the invention. It will also be appreciated that low altitude plants may be grown in a pressure-resistant enclosure which is located at a relatively high altitude location. This could allow cultivation of important crop species at high altitudes to provide a fast-growing nutritious food source in areas where plant growth is particularly limited due to adverse environmental conditions such as cold temperatures, low air pressure, poor nutrient availability etc.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

The claims defining the invention are as follows:

1. An enclosure for growing plants therein, said enclosure including adjustment means for adjusting the level of one or more environmental variables therein so as to at least partially simulate the growing conditions found at a specific altitude.

2. An enclosure according to claim 1, wherein said one or more environmental variables are selected from water levels, broad-spectrum light intensity, UV light intensity, pH, nutrients, air temperature, soil temperature, atmospheric carbon dioxide, atmospheric oxygen and atmospheric pressure.

3. An enclosure according to claim 1 or claim 2, wherein said adjustment means are selected from a water irrigation system, a hydroponic system, a broad spectrum light, a UV light, a nutrient supplementation system, an air heater, a soil heater, an air conditioning unit, a carbon dioxide generator, a carbon dioxide scrubber, an oxygen generator, a hypoxicator, a pressure pump, a vacuum pump and combinations thereof.

4. An enclosure according to any one of the preceding claims including at least one sensor for measuring the level of said at least one environmental variable.

5. An enclosure according to claim 4, further including an automated control system for maintaining at least one environmental variable at a predetermined level, the automated control system being operably linked to a sensor and in control of an adjustment means corresponding to the environmental variable.

6. An enclosure according to any one of the preceding claims, wherein the level of one or more of said variables is adjusted so as to at least partially simulate growing conditions at a higher altitude than the altitude at which the enclosure is located.

7. An enclosure according to claim 6, wherein the air pressure within the enclosure is reduced compared with natural levels found at the altitude at which the enclosure is located.

8. An enclosure according to claim 6 or claim 7, wherein the oxygen level within the enclosure is reduced compared with natural levels found at the altitude at which the enclosure is located.

9. An enclosure according to any one of claims 6 to 8, wherein said broad-spectrum light and/or UV light intensity within the enclosure are increased compared with natural levels found at the altitude at which the enclosure is located.

10. An enclosure according to any one of claims 6 to 9, wherein the overall and/or night-time temperature within the enclosure is reduced compared with natural temperatures found at the altitude at which the enclosure is located.

11. An enclosure according to any one of claims 1 to 5, wherein the level of one or more of said variables are adjusted so as to at least partially simulate the growing conditions at a lower altitude than the altitude at which the enclosure is located.

12. An enclosure according to claim 11, wherein the air pressure within the enclosure is increased compared with natural levels found at the altitude at which the enclosure is located.

13. An enclosure according to claim 11 or claim 12, wherein the oxygen level is increased within the enclosure compared to the natural levels found at the altitude at which the enclosure is located.

14. An enclosure according to any one of claims 11 to 13, wherein said broad-spectrum light and/or UV light levels within the enclosure are reduced compared with natural levels found at the altitude at which the enclosure is located.

15. An enclosure according to any one of claims 11 to 14, wherein the overall and/or night-time temperature is increased compared with natural temperatures found at the altitude at which the enclosure is located.

16. A plant grown in an enclosure according to any one of claims 1 to 15.

17. A harvested plant, or part thereof, derived from a plant according to claim 16.

18. A plant extract obtained from a plant, or part thereof, according to claim 16 or claim 17.

19. A method of altering the characteristics of a plant comprising growing the plant at a first altitude and adjusting the level of one or more environmental variables in proximity to the plant so as to at least partially simulate the growing conditions found at a second altitude.

20. A method according to claim 19, wherein the one or more environmental variables are selected from water levels, broad-spectrum light intensity, UV light intensity, soil type, pH, nutrients, air temperature, soil temperature, atmospheric carbon dioxide, atmospheric oxygen and atmospheric pressure.

21. A method according to claim 19 or claim 20, wherein said plant is selected from goji berry/wolf berry (Lycium barbarum or L. chinense), blueberry (Vaccinium species), tea (Camellia sinensis varieties) and coffee (Coffea canephora or Coffea arabica).

22. A method according to any one of claims 19 to 21, wherein one of said characteristics is the level and/or quality of antioxidants found in said plant or part thereof.

23. A method according to claim 22, wherein the level and/or quality of one or more antioxidants are increased.

24. A computer control system for controlling the growth of plants at a first altitude, the control system being responsive to input obtainable from at least one sensor disposed in proximity to said plants so as to determine a control output for controlling one or more environmental adjustment means to adjust the level of one or more environmental variables in proximity to said plants to expose said plants to growing conditions which at least partially simulate the growing conditions found at a second altitude.

25. A computer control system according to claim 24, further including data relating to the levels of a plurality of environmental variables that occur naturally at each of a plurality of different altitudes.

26. A control system according to claim 25 including input means to allow a user to select a specific altitude whereby the control system queries the data set for that altitude and adjusts one or more of the environmental conditions in proximity to the plants to a level at or near to the level that occurs naturally at that altitude.

27. A computer control system for controlling the growth of plants at a first altitude, the control system being responsive to user input indicative of a target altitude so as to determine a control output for controlling one or more environmental adjustment means to adjust the level of one or more environmental variables in proximity to one or more plants to expose said plants to growing conditions which at least partially simulate the growing conditions found at said target altitude.
